(19) United States
(12) Patent Application Publication
(10) Pub. No.: US 2013/0299270 A1
(43) Pub. Date: Nov. 14, 2013

(54) ELECTRONIC POWER STEERING WITH DITHERED STEERING MOTOR CONTROL

(71) Applicants: Kenneth L. Oblizajek, Troy, MI (US); John D. Sopoci, Commerce Township, MI (US)

(72) Inventors: Kenneth L. Oblizajek, Troy, MI (US); John D. Sopoci, Commerce Township, MI (US)

(73) Assignee: GM GLOBAL TECHNOLOGY OPERATIONS LLC, DETROIT, MI (US)

(21) Appl. No.: 13/466,307

(22) Filed: May 8, 2012

(51) Int. Cl. B62D 6/00; B62D 6/08; B62D 6/02; G05B 11/06

(52) U.S. Cl. 180/446; 318/631

(57) ABSTRACT

Methods and apparatus are provided for a dithered EPS system of a vehicle. The apparatus includes a steering assembly having one or more sensors for sensing user steering input. A controller is responsive to the user steering input for providing a motor control signal. The apparatus also includes a dither signal generator providing a dither signal and a combiner for combining the motor control signal and the dither signal to provide a dithered motor control signal to control the motor of the apparatus. The methods include sensing user steering input via one or more sensors coupled to a steering assembly of a vehicle and generating a motor control signal responsive to the user steering input. A dither signal is generated and combined with the motor control signal to provide a dithered motor control signal that is used to control motor.

### TECHNICAL FIELD

The technical field generally relates to electronic power steering (EPS) systems for vehicles, and more particularly to an improved control system and method for an EPS system for a vehicle.

### BACKGROUND

Conventional electronic power steering (EPS) systems often produce a driver perceptible “stickiness” or reluctance to respond, which typically requires additional driver steering torque to overcome. This “stickiness” (or “stiction” as commonly referred to) condition can be experienced when operating an EPS equipped vehicle at highway speeds while performing minor within-lane steering corrections, that is, at vehicle speeds of approximately 45-80 miles per hour (mph).

Typically, as a vehicle operator begins to correct the heading of an EPS equipped vehicle traveling at highway speeds, a resistance to steer can be felt in the wheel that must be overcome with increased effort. The level of increased effort can be as significant as 0.9 Newton meters (Nm), which many vehicle operators find objectionable or annoying while operating a vehicle.

Accordingly, it is desirable to provide improved control for an EPS system for a vehicle. Also, it is desirable to provide a control system that alleviates the perceivable “stickiness” condition without introducing a perceivable correction signal. Additionally, other desirable features and characteristics of the present disclosure will become apparent from the subsequent description taken in conjunction with the accompanying drawings and the foregoing technical field and background.

### SUMMARY

In accordance with exemplary embodiments, a dithered EPS system is provided for a vehicle. The system comprises a steering assembly having one or more sensors for sensing user steering input. A controller is responsive to the user steering input for providing a motor control signal. The EPS system also includes a dither signal generator providing a dither signal and a combiner for combining the motor control signal and the dither signal to provide a dithered motor control signal to control the motor of the EPS system.

In accordance with exemplary embodiments, a method for controlling a dithered EPS system is provided for a vehicle. The method comprises sensing user steering input via one or more sensors coupled to a steering assembly of a vehicle and generating a motor control signal responsive to the user steering input. A dither signal is generated and combined with the motor control signal to provide a dithered motor control signal which is used to control a motor of an EPS system.

### DESCRIPTION OF THE DRAWINGS

The embodiments will hereinafter be described in conjunction with the following drawing figures, wherein like numerals denote like elements, and wherein:

FIG. 1 is an illustration of a vehicle including an exemplary embodiment;

FIG. 2 is a block diagram of a dithered EPS system in accordance with an exemplary embodiment;

FIG. 3 is a flow diagram of method in accordance with an exemplary embodiment; and

FIG. 4 is a flow diagram of method in accordance with another exemplary embodiment.

### DETAILED DESCRIPTION

The following detailed description is merely exemplary in nature and is not intended to limit application and uses. Furthermore, there is no intention to be bound by any expressed or implied theory presented in the preceding technical field, background, brief summary or the following detailed description.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language.

Additionally, the following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that, although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

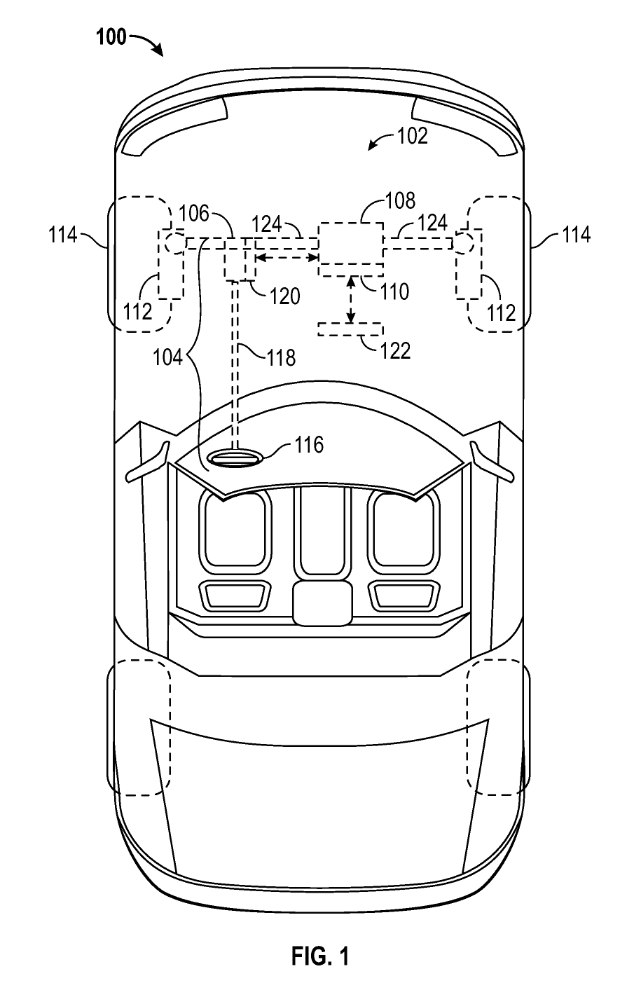

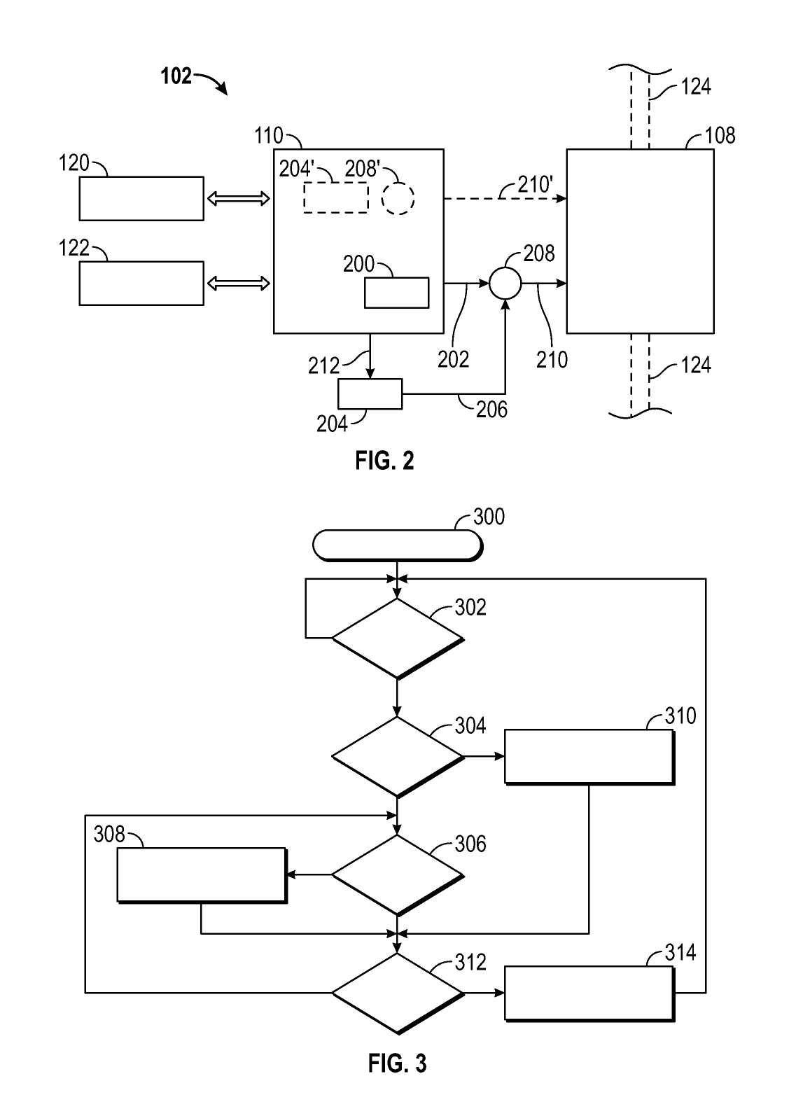

Finally, for the sake of brevity, conventional techniques and components related to vehicle electrical and mechanical parts and other functional aspects of the system (and the individual operating components of the system) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the invention. It should also be understood that FIGS. 1-2 are merely illustrative and may not be drawn to scale.

Referring to the drawings, wherein like reference numbers refer to like components, FIG. 1 shows a vehicle 100 including exemplary embodiments of the present disclosure. The vehicle 100 may be any one of a number of different types of vehicles, such as, for example, a sedan, a wagon, a truck, or a sport utility vehicle (SUV), and may be two-wheel drive (2WD), four-wheel drive (4WD), or all-wheel drive (AWD). The vehicle 100 may also incorporate any one of, or combination of, a number of different types of engines, such as, for example, a gasoline or diesel fueled combustion engine, a flex fuel vehicle (FFV) engine (i.e., using a mixture of gasoline and alcohol), a gaseous compound (e.g., hydrogen and/or natural gas) fueled engine, a combustion/electric motor hybrid engine, and an electric motor.

The illustrated embodiment of the vehicle 100 includes an electronic power steering (EPS) system 102. The EPS system 102 includes a steering assembly 104, a steering gear assembly 106, a motor assembly 108, a controller 110 and two wheel steering assemblies 112 each coupled to a wheel (and tire) 114. These are, of course, only some of the components, devices, assemblies, systems, etc. that may be used with an EPS system 102, as others known in the art could be used in lieu of or in addition to those mentioned here. While a rack mounted EPS is illustrated in FIG. 1, it will be appreciated that the advantages of the disclosed embodiments are equally applicable to a column mounted EPS.

Steering assembly 104 includes a steering wheel 116 rotatably coupled to a steering connection assembly 118, which transmits the steering intentions of a driver to the other portions of EPS system 102. Typically, a conventional steering connection assembly 118 includes one or more steering shafts and steering joints that are part of steering connection assembly 118. It should of course be appreciated that the foregoing description is only of a general and exemplary nature as myriad steering connection assembly embodiments, including those having more, less and/or different components could also be used.

The steering connection assembly 118 is coupled to a steering gear assembly 106, which converts rotational motion from the steering connection assembly 118 into lateral or cross-vehicle motion that can be used to turn the vehicle's wheels 114. In some embodiments, steering gear assembly 106 may be realized as a rack and pinion steering gear assembly, although other steering gear assemblies may be used.

The motor assembly 108 provides the EPS system 102 with power assist in order to supplement the manual steering force generated by the driver. This makes steering easier and more effortless. Typically, the motor assembly 108 includes an electric motor, a power input, and one or more gears, pulleys, belts, bearings, etc. for achieving preferred ratios of motor armature to rack velocities. Depending upon the particular embodiment implemented, the electric motor may be a brushless motor, brushed motor, or any other type of motor employed in the art as will be appreciated by those skilled in the art.

The motor assembly 108 operates to provide power assist to steering the vehicle 100 under direction of a controller 110. The controller 110 performs the computation and control functions of the EPS system 102, and may comprise any type of processor or multiple processors, single integrated circuits such as a microprocessor, or any suitable number of integrated circuit devices and/or circuit boards working in cooperation to accomplish the functions of a processing unit. During operation, the controller 110 receives data from sensors (or sensor arrays) 120 and 122, which is used by the controller to determine whether, and to what extent, to provide power assist to the steering effort of the driver of the vehicle 100.

Sensors 120 are coupled to (or integrated within) the steering gear assembly 106. Any sensor capable of taking measurements that provide steering information from the steering connection assembly 118 could be used within sensor 120. As an example, and not a limitation, sensors measuring steering input such as steering wheel angle; steering wheel torque; steering wheel velocity; steering wheel acceleration and steering wheel torque gradient could be useful in sensor array 120.

In addition to steering input derived from driver actions, other vehicle data or conditions may be useful in determining whether (and to what extent) to provide power assisted steering. Accordingly, sensors 122 may be distributed throughout the vehicle 100, but for convenience, are illustrated as a single sensor array coupled to the controller 110. Vehicle sensors that may be useful in determining how to control the motor assembly 108 include, but are not limited to, vehicle speed; vehicle fore-aft acceleration; vehicle lateral acceleration; driven wheel speed and non-driven wheel speed.

In operation of the EPS system 102, the motor assembly 108 provides power assist to move wheel steering assemblies 112, which are coupled to the motor assembly via tie rods 124. Typically, the wheel steering assemblies 112 carry the vehicle's tires and include a number of conventional revolving components. For example, it is common for the wheel steering assemblies 112 to include a rotating hub, a rotating disk or rotor, and a wheel with an installed tire. All of these devices co-rotate when the vehicle 100 is being driven. A disk brake system (not shown) can also be installed on the vehicle to interact with wheel steering assembly 112, although other braking systems like drum brakes could be used as well.

As noted earlier, one drawback of conventional EPS systems is perceived by the vehicle driver as a “stickiness” or reluctance to respond, which typically requires additional driver steering torque to overcome. Accordingly, exemplary embodiments of the present disclosure supplement the control signal supplied from the controller 110 to the motor assembly 108 with a “dither” signal. “Dithering” the motor control signal, that is, the intentional introduction of noise or other signal into the motor control signal, alleviates the stickiness sensation and allows for a smooth and easy steering experience for the vehicle driver as will be explained in more detail in connection with FIG. 2.

Referring now to FIG. 2, wherein like reference numbers refer to like components, there is shown a block diagram useful for understanding the dithered EPS system 102 in accordance with exemplary embodiments. As discussed in connection with FIG. 1, sensors (or sensor arrays) 120 and 122 provide steering input and vehicle data to the controller 110. The controller 110 may include a memory 200 that contains operational programs, instructions and/or variables or parameters useful for processing the sensor inputs and determining whether (and to what extent) to control the motor assembly 108. The memory 200 can be any type of suitable memory. This would include the various types of dynamic random access memory (DRAM) such as SDRAM, the various types of static RAM (SRAM), and the various types of non-volatile memory (PROM, EPROM, and flash). The controller 110 processes the sensor inputs and provides a motor control signal 202 to the motor assembly 108 to provide power assist to steering the vehicle.

In exemplary embodiments of the present disclosure, a dither signal generator 204 is included in the EPS system 102 and provides a dither signal 206 that is combined (e.g., summed, integrated, averaged) in combiner 208 to provide a dithered motor control signal 210. The combination of the dither signal 206 to the motor control signal 202 alleviates the perception of “stickiness” by having the motor assembly 108 in relative constant motion due to the ever changing dithered motor control signal 210. Thus, the dither signal may be any signal that would cause the motor assembly 108 to operate (even minutely) in the absence of a more direct instruction (or no instruction) to move as compared to the motor control signal 202. In one embodiment, the dither signal 206 is realized as a sine wave having a frequency of approximately 30 hertz. In other embodiments, other signal types may be employed such as, without limitation, random white or pink noise, filtered random white or pink noise, periodic waves comprising at least one sinusoidally varying component as, for example, square waves, triangular waves, and/or sawtooth waves.

In one embodiment, the dither signal generator 204 and combiner 208 may be separate units working in cooperation with the controller 110. In other embodiments, the dither signal generator 204′ and combiner 208′ may be integrated within the controller 110 to provide the dithered motor control signal 210′. Also, some embodiments utilizing the dither signal generator 204 provide a continuous dither signal 206. In other embodiments, the dither signal generator 204 is controlled (via programming line(s) 212) to conditionally provide the dither signal 206 depending upon the steering input, vehicle data or driving conditions. In still other embodiments, the controller 110 controls (via programming line(s) 212) the dither signal generator 204 to vary one or more parameters of the dither signal 206 responsive to driver steering input, vehicle data or driving conditions. Examples of such dither signal parameter modification include, but are not limited to, amplitude; frequency; waveform and duty cycle of the dither signal 206.

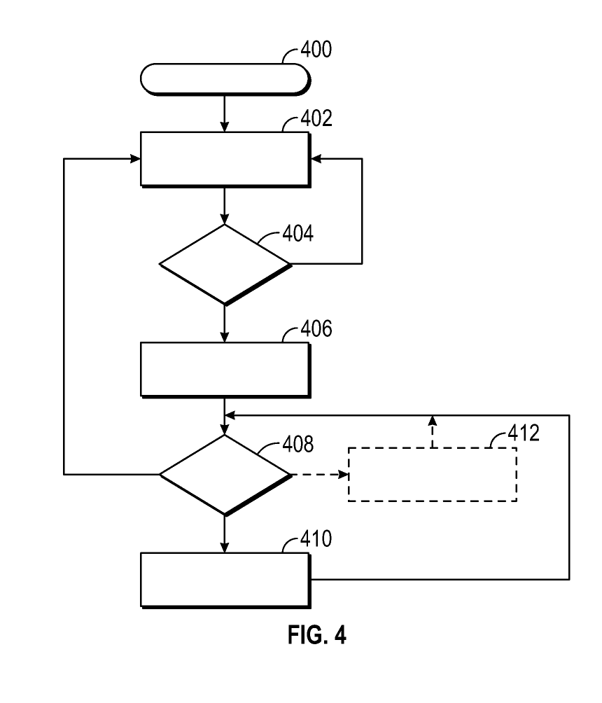

FIGS. 3-4 are flow diagrams useful for understanding the method of the disclosure for providing a dithered EPS system. The various tasks performed in connection with the methods of FIGS. 3-4 may be performed by software, hardware, firmware, or any combination thereof. For illustrative purposes, the following description of the methods of FIGS. 3-4 may refer to elements mentioned above in connection with FIGS. 1-2. In practice, portions of the methods of FIGS. 3-4 may be performed by different elements of the described system. It should also be appreciated that the methods of FIGS. 3-4 may include any number of additional or alternative tasks and that the methods of FIGS. 3-4 may be incorporated into a more comprehensive procedure or process having additional functionality not described in detail herein. Moreover, one or more of the tasks shown in FIGS. 3-4 could be omitted from an embodiment of the methods of FIGS. 3-4 as long as the intended overall functionality remains intact.

FIG. 3 illustrates a method 300 for providing a conditional dither motor control signal. According to exemplary embodiments, the method 300 is performed by the controller (110 of FIG. 2) and begins with a determination (decision 302) of whether a condition has been sensed or data provided by the sensors (120 or 122 of FIG. 2) for which the dither signal (206 in FIG. 2) may be useful for controlling the motor assembly (108 in FIG. 2). If so, decision 304 determines whether the dither signal generator (204 in FIG. 2) is currently active (On). If so, decision 306 determines whether one or more parameters of the dither signal should be modified responsive to the sensor data. An affirmative determination from decision 306 causes step 308 to modify the dither signal, such as, for example, by varying the amplitude; frequency; waveform or duty cycle (or some combination thereof) of the dither signal.

Referring back to decision 304, if the determination of decision 304 is that the dither signal generator is not currently active (e.g., vehicle stopped or operating at low speeds), step 310 activates the dither signal generator and the routine proceeds to decision 312. Also, the routine proceeds to decision 312 following a negative determination of decision 306 or after step 308 modifies the dither signal.

Decision 312 determines whether the condition or sensor data that required the dither signal has cleared or dissipated. If not, the routine continues to loop decision 306 and 308 (if required) until the condition clears, at which time step 314 deactivates the dither signal generator and the routine continues by looping back to the beginning and decision 302.

FIG. 4 illustrates a method 400 for providing a continuous dither motor control signal. According to exemplary embodiments, the method 400 is performed by the controller (110 of FIG. 2) and begins at step 402 with applying the default dither signal (206 in FIG. 2) to the motor control signal (202 in FIG. 2) to provide the dithered motor control signal (210 in FIG. 2). In this embodiment, the dither signal generator (204 in FIG. 2) runs continuously; however, it may be advantageous to vary one or more parameters of the dither signal from time to time. Accordingly, decision 404 determines whether a sensed condition or data indicates that one or more parameters of the dither signal should be modified. If the dither signal should not be modified, the routine loops back to step 402, however, an affirmative determination from decision 404 causes step 406 to modify the dither signal, such as, for example, by varying the amplitude; frequency; waveform or duty cycle (or some combination thereof) of the dither signal. Next, decision 408 determines whether the condition or sensor data that required the dither signal to be modified has cleared or dissipated. If not, step 410 causes the dither signal generator to continue to provide the modified dither signal until such time as the determination of decision 408 is that the condition has cleared, at which time the default dither signal is reestablished in step 402. Optionally, the method 400 may include step 412, which may cause the dither signal to be further modified with every loop back to decision 408 until it is determined that the sensed condition or data has cleared.

Accordingly, a dithered EPS system is provided for a vehicle. The dithered EPS system according to the various disclosed embodiments alleviates the driver perceived “stickiness” problem of conventional EPS system. While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing summary and detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method, comprising:
sensing user steering input via one or more sensors coupled to a steering assembly of a vehicle;
generating a motor control signal responsive to the user steering input;
generating a dither signal;
combining the motor control signal and the dither signal to provide a dithered motor control signal; and
controlling a motor via the dithered motor control signal.

2. The method of claim 1, further comprising controlling a steering assembly via the motor to steer the vehicle during operation.

3. The method of claim 2, further comprising varying one or more parameters of the dither signal.

4. The method of claim 3, further comprising varying one or more of the following group of parameters for the dither signal: amplitudes, frequencies, waveform and duty cycle.

5. The method of claim 1, further comprising sensing one or more of the following group of user steering inputs: steering wheel angle, steering wheel torque, steering wheel velocity, steering wheel acceleration and steering wheel torque gradient to generate the motor control signal.

6. The method of claim 1, further comprising sensing and providing one or more of the following group of vehicle information to the controller: vehicle speed, vehicle fore-aft acceleration, vehicle lateral acceleration, driven wheel speed and non-driven wheel speed to generate the motor control signal.

7. A system, comprising:
a steering assembly;
one or more sensors coupled to the steering assembly for sensing user steering input;
a controller coupled to the one or more sensors for providing a motor control signal responsive to the user steering input;
a dither signal generator providing a dither signal;
a combiner coupled to the controller and the dither signal generator for combining the motor control signal and the dither signal to provide a dithered motor control signal; and
a motor coupled to the combiner for receiving the dithered motor control signal.

8. The system of claim 7, wherein the dither signal generator is coupled to the controller for varying one or more parameters of the dither signal.

9. The system of claim 8, wherein the dither signal generator varies one or more of the following group of parameters for the dither signal: amplitudes, frequencies, waveform and duty cycle.

10. The system of claim 7, wherein the dither signal generator is responsive to the controller for conditionally providing the dither signal.

11. The system of claim 7, wherein the one or more sensors coupled to the steering assembly sense one or more of the following group of user steering inputs: steering wheel angle; steering wheel torque; steering wheel velocity; steering wheel acceleration and steering wheel torque gradient.

12. A vehicle incorporating the system of claim 7, further comprising:
a steering connection assembly coupled to the motor;
wheels coupled to the steering connection assembly; and
one or more sensors coupled to the vehicle and the controller for providing vehicle information to the controller for use in providing the motor control signal.

13. The vehicle of claim 12, wherein the one or more sensors provide one or more of the following group of vehicle information to the controller: vehicle speed; vehicle fore-aft acceleration; vehicle lateral acceleration; driven wheel speed and non-driven wheel speed.

14. A vehicle, comprising:
a steering assembly;
one or more sensors coupled to the steering assembly for sensing user steering input;
a controller coupled to the one or more sensors for providing a motor control signal responsive to the user steering input;
a dither signal generator providing a dither signal;
a combiner coupled to the controller and the dither signal generator for combining the motor control signal and the dither signal to provide a dithered motor control signal;
a motor coupled to the combiner for receiving the dithered motor control signal;
a steering connection assembly coupled to the motor; and
wheels coupled to the steering connection assembly;
wherein the motor is responsive to the dithered motor control signal to steer the wheels by moving the steering connection assembly.

15. The vehicle of claim 14, wherein the dither signal generator is coupled to the controller for varying one or more parameters of the dither signal.

16. The vehicle of claim 15, wherein the dither signal generator varies one or more of the following group of parameters for the dither signal: amplitudes, frequencies, waveform and duty cycle.

17. The vehicle of claim 14, wherein the dither signal generator conditionally provides the dither signal.

18. The vehicle of claim 14, wherein the one or more sensors coupled to the steering assembly sense one or more of the following group of user steering inputs: steering wheel angle, steering wheel torque, steering wheel velocity, steering wheel acceleration and steering wheel torque gradient.

19. The vehicle of claim 14, further comprising one or more additional sensors provide one or more of the following group of vehicle information to the controller: vehicle speed; vehicle fore-aft acceleration, vehicle lateral acceleration, driven wheel speed and non-driven wheel speed.

20. The vehicle of claim 19, wherein the controller is coupled to the one or more additional sensors for providing the motor control signal responsive to the user steering input and the information from the one or more additional sensors.
